(19) United States
(12) Patent Application Publication
(10) Pub. No.: US 2019/0133850 A1
(43) Pub. Date: May 9, 2019

(54) Rescue stretcher for rescuing persons

(71) Applicant: Christine Offen, Berlin (DE)

(72) Inventor: Christine Offen, Berlin (DE)

(21) Appl. No.: 15/821,788

(22) Filed: Nov. 23, 2017

(30) Foreign Application Priority Data
Nov. 7, 2017 (EP) 17001818.8

(51) Int. Cl. A61G 1/01; A61G 1/048; A61G 1/013

(52) U.S. Cl. CPC A61G 1/01; A61G 2210/90; A61G 1/013; A61G 1/048

(57) ABSTRACT

The invention relates to a rescue stretcher for rescuing persons with an substantially rectangular, support litter which is configured to be rolled up and/or folded together and is made of a flexible, tear-resistant, water-proof sheet material, and with at least two fixed carrying loops on each longitudinal side of the rectangular support litter, wherein on the inner receiving surface of the support litter a cold protection unit consisting of a blanket-like heat maintaining element and, replaceably provided thereon a substrate configured to absorb bodily fluids, is detachable fastened and which when the support litter is being carried by the carrying loops forms an envelope-like, cold-insulated bedding for the person to be carried.

### FIELD OF THE INVENTION

The present invention relates to a rescue stretcher for rescuing persons.

### BACKGROUND

A number of different rescue stretchers is known. Normally, rescue stretchers comprise rods or a trough to give the rescue stretcher rigidity. In this way a person can be easily placed on the rescue stretcher and transported in a stable manner. Although rigid rescue stretchers, for example rescue stretchers that are occasionally used by rescue services, provide good protection for the person to be rescued, they are difficult to handle. In confined environments it can be difficult or even impossible to move a solid stretcher, which usually has a length of more than 2 m and a width of 50 cm. Furthermore, due to their dimensions such rigid stretchers are not only unwieldy to transport, but also to store.

Flexible rescue stretchers are also known. These are of a fabric-like design and therefore flexible. Flexible stretches can be tightly packed, in particular rolled up, and are therefore easy to store and to transport. Such rescue stretchers are used in rescues from heights for example. For transporting a person these can then be longitudinally half rolled round the person to be rescued, so that the person is stabilised in the rescue stretcher. Such rescue stretchers often have four or six hand grips, e.g. on the right and left in the shoulder area, in the middle and at the foot end. With these up to six rescuers can easily carry the rescue stretcher.

In U.S. Pat. No. 4,124,908 A an overall flexible rescue support base for rescuing persons is described which is not only flexible to use but can also be stored rolled up when not in use, for example in a building at a predetermined location.

DE 20316498 U1 also discloses a rescue support base for rescuing persons with a substantially rectangular support mat made of an substantially tear-resistant flat synthetic material with a high tensile strength, with carrying loops on the support mat and person-securing straps distributed over the length of the support mat.

In addition, known from DE 10 2014 016 509 A1 is a rescue stretcher that can be rolled up and has at least two straps to secure a person in the longitudinal direction of the rescue stretcher. The straps for securing a person in the longitudinal direction of the rescue stretcher are arranged in such a way that the straps are attached above a first area, wherein the first area is designed to hold the shoulders of a person on the rescue stretcher. The rescue stretcher has a foot bar, wherein the foot bar can be adjusted in the longitudinal direction of the stretcher.

The invention is based on the problem of providing a rescue stretcher which during rescue guarantees cold-insulated, dry bedding of the person to be transported on the rescue stretcher.

### SUMMARY

The problem is solved by a rescue stretcher with the features set out in claim 1. Advantageous embodiments and further developments of the rescue stretcher according to the invention are set out in the dependent claims.

The rescue stretcher according to the invention comprises a substantially rectangular, support litter which is configured to be rolled up and/or folded together and is made of a flexible, tear-resistant, water-proof sheet material wherein at least two carrying loops are fixed on each longitudinal side of the support litter and on which on the inner receiving surface of the support litter accommodating the person to be rescued a cold protection unit comprising or consisting of a blanket-like heat maintaining element and, replaceably provided thereon a substrate absorbing bodily fluids, is detachably fastened and which when the support litter is being carried by means of the carrying loops forms an envelope-like, cold-insulated bedding for the person to be carried.

According to an embodiment, when the support litter is being carried by means of the carrying loops, the envelope-like, cold-insulating bedding formed by the cold protection unit is configured to be closed in an unlockable manner by hook and loop fastener elements assigned to each other which are each provided on the undersurface of the blanket-like heat maintaining element in the area of the longitudinal edges of the latter.

According to an embodiment, the rectangular support litter when being carried by the carrying loops, together with the blanket-like heat maintaining element and the bodily fluid-absorbing substrate positioned thereon, forms the envelope-like bedding for the person to be carried.

The rectangular support litter is configured to, when being carried by the carrying loops, together with the blanket-like heat maintaining element and the bodily fluid-absorbing substrate positioned thereon, forming the envelope-like bedding for the person to be carried, be closed by means of a hook and loop fastener closure or zip fastener provided along its longitudinal edges.

The blanket-like heat maintaining element of the cold protection unit can consist of a laminated layer of a flexible, closed-pore foam film, in particular a cold-insulating polyethylene film, the surface of which can be coated with a thin cold-insulating metal layer such as, for example, an aluminium layer with a thickness in the range of 0.6μ to 50μ. The metal layer is heat-reflecting, which is of advantage particularly in the case of patients with burns. In addition the material of the blanket-like heat maintaining element is particularly skin-friendly, anti-allergenic and breathable, ruling out colonisation by mites and/or bacteria.

The polyethylene film can have a thickness of 0.7 mm to 5 mm and comprises a multiplicity of air bubbles, wherein, for example in the case of a film thickness of 2 mm up to 2 million air bubbles per m² area can be provided. Through this the polyethylene film is both flexible and has closed pores which results in an increased insulation effect against heat loss, imperviousness to moisture and low or non-flammability of the blanket-like heat maintaining element.

The undersurface with the polyethylene film provided with the cold insulating layer is connected in a detachable adhesive manner to the inner receiving surface of the support litter by means of adhesive points and/or adhesive strip(s) or through full-surface adhesion.

According to an embodiment, the blanket-like heat maintaining element of the cold protection unit is formed of a maximum of three metal-coated cold protection films which are connected to each other by elastic threads, wherein the undersurface of the cold protection film at the bottom of the layer is detachably connected to the inner receiving surface of the support litter by means of adhesive points, adhesive strips or through full-surface adhesion.

The support litter and the blanket-like heat maintaining element of the cold protection unit are connected to each other in a detachable manner by means of a double-sided adhesive tape. Equally, the bodily fluid-absorbing substrate can be detachably fixed on the inner surface of the heat maintaining element by means of adhesive points and/or adhesive strips.

Additionally, heat pads can be integrated into the blanket-like heat maintaining element of the cold protection unit which maintain the body temperature of the enveloped person to be rescued. On each longitudinal side of the rectangular support litter, for example, three carrying loops can be provided so that the support litter can be carried even with a maximum loading of 500 kg.

The support litter and the blanket-like heat maintaining element of the cold protection unit are connected to each other in a detachable manner by means of a double-sided adhesive tape. Additionally, heat pads can be integrated into the blanket-like heat maintaining element of the cold protection unit.

According to an embodiment, the bodily fluid-absorbing substrate is a highly absorbent sheet, e.g. a non-woven sheet, with an absorption volume in the range of 1 to 9 litres, more particularly 4 to 6 litres, e.g. 4 litres of bodily fluids. A special absorbent core with an absorption volume of up to 8 litres of bodily fluids can be removable integrated into the bodily-fluid absorbing substrate or sheet. The dimensions of the absorbent core which can be removed from the bodily-fluid absorbing substrate or sheet are typically in the range of a length of 180 cm to 220 cm and a width of 40 cm×80 cm and are, for example 200 cm×60 cm.

According to an embodiment, at the foot end of the support litter a foot sack can be applied which is configured to be fasted interchangeably and/or adjustably on the support litter. When the foot sack is seen from above, the upper part thereof can be closed in two parts and along the centreline by means of a second zip fastener.

On the inside receiving surface of the support litter a closeable document pocket can be attached in such a way that when the envelope-like bedding is being carried by the carrying loops it is accessible from the outside through the opening area.

According to an embodiment, the rectangular support litter, on the longitudinal sides of which at least two carrying loops are fixed, together with the cold protection unit, comprising the blanket-like heat maintaining element and the bodily fluid-absorbing substrate replaceably attached thereto, which is detachably fastened to the inner receiving surface of the support litter, can be folded together to form a pack with a surface area of approx. 35 cm×approx. 30 cm and a height of approx. 15 cm. This pack can be kept in a small-sized stackable vacuum packaging and have a weight of approximately 1.5 kg.

Through the detachably positioned cold protection unit positioned on the support litter, the rescue stretcher according to the invention allows effective body heat-retaining bedding of the person to the rescued on the support litter, wherein the bodily fluid-absorbing substrate of the cold protection unit, in which the person to be rescued is bedded, ensures that if necessary blood and secretions, for example, of the bedded person are absorbed and his/her body heat is maintained at a constant necessary temperature. Additionally, the entire cold protection unit, detachably fastened on the support litter, or only the body-fluid absorbing substrate, which is detachably fastened to the blanket-like heat maintaining element, and/or the absorption core, which is detachably integrated on the blanket-like heat maintaining element or in the bodily fluid-absorbing non-woven sheet, can if required, e.g. in the case of the person to rescued needing to be re-bedded, be replaced without problem. The blanket-like heat maintaining element can also be replaced if required.

### BRIEF DESCIRPTION OF THE DRAWINGS

The rescue stretcher according to the invention will be explained in more detail below with the aid of the drawings. In the drawings:

FIG. 1 shows a schematic view from above of a rescue stretcher according to at least one embodiment of the present invention,

FIG. 2 shows a schematic view from above of another rescue stretcher according to at least one embodiment of the present invention,

FIG. 3 shows a schematic cross-section of a further rescue stretcher according to at least one embodiment of the present invention,

FIG. 4 shows a schematic cross-sectional view of part of a further rescue stretcher according to at least one embodiment of the present invention, and

FIG. 5 shows a transparent view from above of a vacuum packaging in which a further rescue stretcher according to at least one embodiment is vacuum-packed in the folded up state.

### EMBODIMENTS

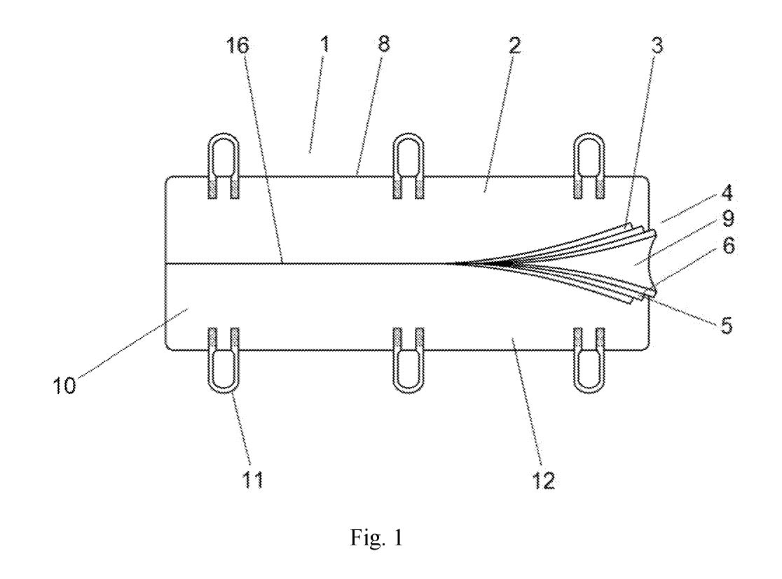

FIG. 1 shows a schematic view from above of a rescue stretcher 1 according to at least one embodiment of the present invention, wherein the support litter 2 as well as the cold protection unit 4 comprising the blanket-like heat maintaining element 5 and the bodily fluid-absorbing substrate 6 detachably fixed thereon, form a cold-insulating, envelope-like bedding 7 for the person to be rescued. The envelope-like bedding 7 can be closed along longitudinal edge 8 lying opposite each other by means, for example, of a closure 16, which is a hook and loop fastener, or a first zip fastener in such a way that the upper body, in particular the head of the person to be rescued comes to lie in an opening area 9 of the envelope-like (mantle-like) bedding 7 that is accessible from outside.

As shown in FIG. 1 on the outside of the support substrate 2 six carrying loops 11 are attached in a tear-resistant manner in such a way that on the formed envelope-like bedding 7 on each of both longitudinal sides 12 three of the carrying loops 11 are positioned opposite each other, which on each longitudinal side 12 of the envelope-like bedding 7 are each arranged at an equal distance from one another, so that the person to be rescued held in the envelope-like bedding 7 of the rescue stretcher 1 can be carried by six rescuers.

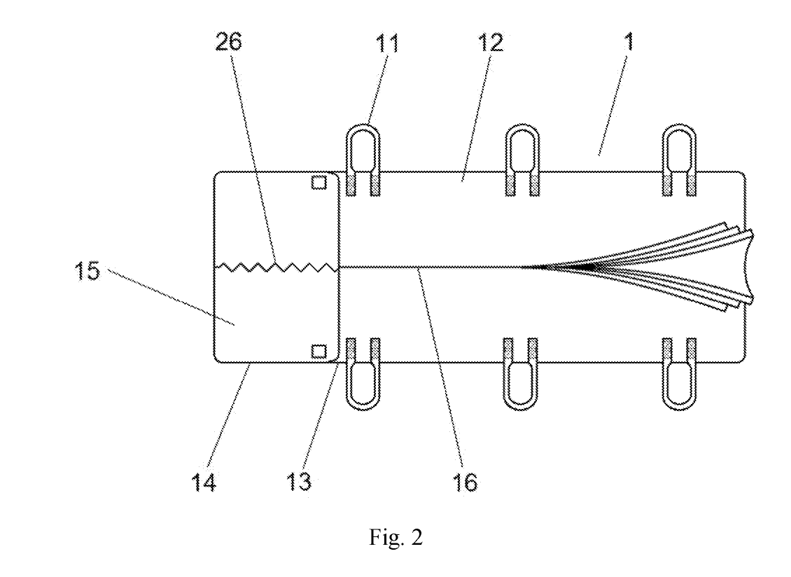

In a different embodiment of the rescue stretcher 1 shown in FIG. 2, at the foot end 13 thereof a removable and/or adjustable foot sack 14 is attached to the rescue stretcher 1 in such a way that the feet of the person positioned in the envelope-like bedding 7 of the rescue stretcher 1 can be accommodated in the foot sack 14 and the person can, in particular, be carried secured towards the bottom in the envelope-like bedding 7 in the oblique or upright transporting position of the rescue stretcher 1. In the form of embodiment shown in FIG. 2, seen from above the upper part 15 of the foot sack 14 is in two parts and is closable along the centreline by means of a second zip fastener 26. For example, the dimensions of the foot sack are approximately 35 cm×30 cm×15 cm.

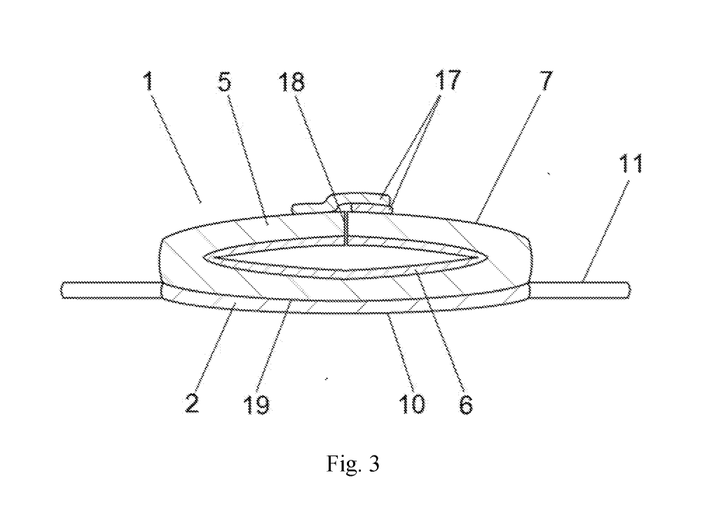

FIG. 3 shows a schematic cross-section of a further rescue stretcher 1 according to at least one embodiment of the present invention wherein on the inner receiving surface 3 of the support litter 2 of the rescue stretcher 1 the cold protection unit 4 is positioned as the envelope-like bedding 7. The latter is formed by the blanket-like heat maintaining element 5 which, for example, can comprise a layer of a maximum of three metal-coated cold protection films connected to each other by elastic threads, and the bodily fluid-absorbing substrate 6 replaceably positioned on its inside. The latter can, for example, be a highly absorbent non-woven sheet with an absorption volume of, for example, 4 litres of bodily fluids. The envelope-like bedding 7 is, as shown in FIG. 3, closed through interlinking hook and loop fastener closure elements 17 which are positioned in the area of the longitudinal edges 18 of the blanket-like heat maintaining element 5 on its undersurface or on the lowermost layer of the metal-coated cold protection film 23 of the latter.

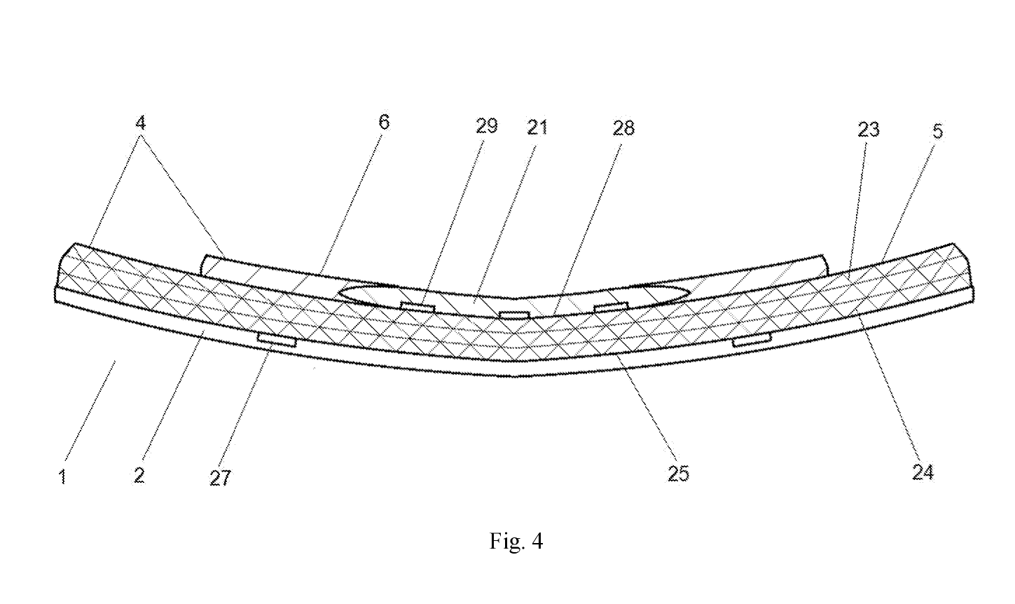

As shown in FIG. 4 illustrating a schematic cross-sectional view of a part of a further rescue stretcher according to at least one embodiment of the present invention, the blanket-like heat maintaining element 5 of the cold protection unit 4 is formed of a layer of three metal-coated cold protection films 23 which are connected to each other by elastic threads 24. The undersurface 25 of the cold protection film 23 at the bottom of the layer is detachably connected to the inner receiving surface 3 of the support litter 2 by means of adhesive points or adhesive strips 27 positioned at a distance from one another or through full-surface adhesion. On the upper surface 28 of the three cold protection films 23 lying on top of one another in the layer a highly-absorbent non-woven sheet is positioned as the bodily fluid-absorbing substrate 6, in the centre of which a special absorbent core 21 with an absorption volume of up to 8 litres of bodily fluids is integrated. With its undersurface 28 the absorption core 21 is fastened, in a quickly replaceable manner, by means of adhesive points or adhesive strips 29, arranged at a distance from one another, on the upper surface 28 of the uppermost cold protection film 23 in the layer of the blanket-like heat maintaining element 5.

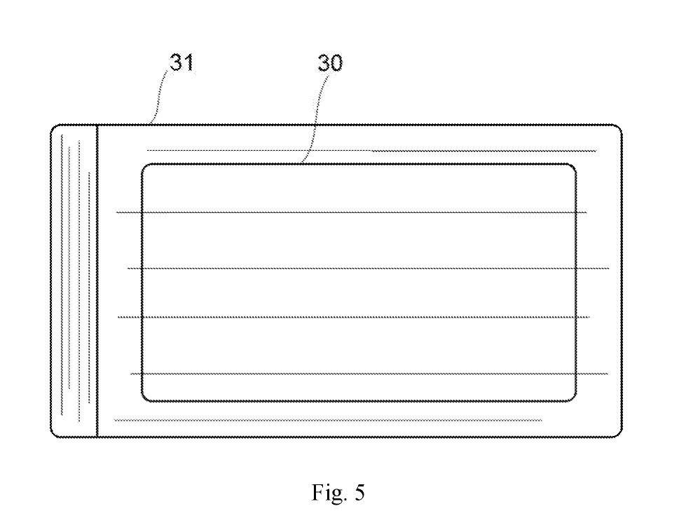

FIG. 5 shows a transparent view from above of a vacuum packaging 31 in which a further rescue stretcher 1 according to at least one embodiment of the present invention is vacuum-packed in the folded up state. The rectangular support litter 2, on the longitudinal sides of which at least two carrying loops are fixed, together with the cold protection unit 4, comprising the blanket-like heat maintaining element 5 and the bodily fluid-absorbing substrate 6 replaceably attached thereto, which is detachably fastened to the inner receiving surface 3 of the support litter 2, can be folded together to form a pack 20 with a surface area of approx. 35 cm×approx. 30 cm and a height of approx. 15 cm and the pack kept in vacuum-packed in a vacuum packaging 21 that can stacked in a small area.

It is to be understood that the embodiments of the present invention are not restricted to the special structures, process steps, or materials disclosed herein, but are extended to equivalents thereof as would be recognized by those ordinarily skilled in the relevant arts.

It is to be understood that the terminology employed herein is only used to describe certain embodiment and should not be interpreted as limiting. The described features, structures or characteristics can be combined in any suitable manner in one or more embodiments.

### LIST OF REFERENCE NUMBERS

1 Rescue stretcher

2 Support litter

3 Inside receiving surface of the support litter

4 Cold protection unit

5 Blanket-like heat maintaining element

6 Bodily fluid-absorbing substrate

7 Envelope-like bedding

8 Longitudinal edges of the envelope-like bedding

9 Opening area of the envelope-like bedding

10 Outer surface of the support litter

11 Carrying loops

12 Longitudinal sides of the envelope-like bedding

13 Foot end of the envelope-like bedding

14 Foot sack

15 Upper part of the foot sack

16 Hook and loop fastener closure, first zip fastener

17 Hook and loop fastener closure elements

18 Longitudinal edges of the blanket-like heat maintaining element

19 Undersurface of the blanket-like heat maintaining element

20 Longitudinal edges of the support litter

21 Absorbent core

22 Double-sided adhesive tape

23 Cold protection films

24 Elastic threads

25 Undersurface of the lowermost cold protection films

26 Second zip fastener

27 Adhesive points, adhesive strips for attaching cold protection films

28 Undersurface of the absorbent core

29 Adhesive points or adhesive strips for replaceable absorbent core fastening

30 Folded-up pack

31 Vacuum packaging

1. A Rescue stretcher for rescuing persons with a substantially rectangular, support litter configured to be rolled up and/or folded together and being made of a flexible, tear-resistant, water-proof sheet material, and with at least two fixed carrying loops on each longitudinal side of the rectangular support litter, wherein on the inner receiving surface of the support litter a cold protection unit comprising a blanket-like heat maintaining element and, replaceably provided thereon, a substrate configured to absorb bodily fluids is detachably fastened and which when the support litter is being carried by the carrying loops forms an envelope-like, cold-insulated bedding for the person to be carried, wherein at the foot end of the support litter a foot sack is fixed interchangeably and/or adjustably by way of a book and loop fastener closure, wherein, when seen from above, the upper part of the foot sack is configured to be closed in two parts and along the centerline by a second zip fastener.

2. A Rescue stretcher according to claim 1, wherein when the support litter is being carried by means of the carrying loops the envelope-like bedding formed by the cold protection unit is configured to be closed in a detachable manner by hook and loop fastener elements assigned to each.

3. A Rescue stretcher according to claim 1, wherein the rectangular support litter, when being carried by the carrying loops, together with the blanket-like heat maintaining element and the bodily fluid-absorbing substrate positioned thereon, forms the envelope-like bedding for the person to be carried.

4. A Rescue stretcher according to claim 1, wherein the rectangular support litter, which when being carried by the carrying loops together with the blanket-like heat maintaining element and the bodily fluid-absorbing substrate positioned thereon, forms the envelope-like bedding for the person to be carried, is configured to be closed by means of a hook and loop fastener closure or a first zip fastener running along the longitudinal edges of the support litter.

5. A Rescue stretcher according to claim 1, wherein the support litter and the blanket-like heat maintaining element of the cold protection unit are connected to each other in a detachable manner by means of a double-sided adhesive tape.

6. A Rescue stretcher according to claim 1, wherein the blanket-like heat maintaining element of the cold protection unit is formed of a maximum of three metal-coated cold protection films which are connected to each other by elastic threads, wherein the undersurface of the cold protection film at the bottom of the layer is detachably connected to the inner receiving surface of the support litter by adhesive points, adhesive strips or through full-surface adhesion.

7. A Rescue stretcher according to claim 1, wherein heat pads are integrated into the blanket-like heat maintaining element of the cold protection unit.

8. A Rescue stretcher according to claim 1, wherein the bodily fluid-absorbing substrate is a highly absorbent sheet with an absorption volume in the range of 2 to 9 liters of bodily fluids.

9. A Rescue stretcher according to claim 1, wherein integrated into the bodily fluid-absorbing substrate or sheet is a removable fixed absorbent core with an absorption volume of maximum 9 liters of bodily fluids.

10. A Rescue stretcher according to claim 9, wherein the bodily fluid-absorbing sheet is a non-woven fabric sheet with an integrated non-woven fabric absorbent core made of cellulose and high-absorbent polymers.

11. A Rescue stretcher according to claim 1, wherein the support litter has a maximum load-bearing capacity of 500 kg.

12. (canceled)

13. A Rescue stretcher according to claim 1, wherein fastened on the inside receiving surface of the support litter is a closeable document pocket which is positioned in such a way that when the envelope-like bedding is being carried by the carrying loops it is accessible from the outside through the opening area.

14. A Rescue stretcher according to claim 1, wherein the rectangular support litter, on the longitudinal sides of which at least two carrying loops are fixed, together with the cold protection unit, comprising the blanket-like heat maintaining element and the bodily fluid-absorbing substrate replaceably attached thereto, which is detachably fastened to an inner receiving surface of the support litter, is configured to be folded together to form a pack with a surface area of approximately 35 cm×approximately 30 centimeters and a height of approximately 15 centimeters.

15. A Rescue stretcher according to claim 14, wherein the pack is configured to be accommodated in a stackable vacuum package.
